(19) United States
(12) Patent Application Publication
(10) Pub. No.: US 2002/0018856 A1
(43) Pub. Date: Feb. 14, 2002

(54) Process and device for applying fluid to a substrate, especially an adhesive to hygienic articles

(75) Inventors: Hubert Kufner, Lunenburg (DE); Reinhard Meyer, Bleckede (DE); Thomas Burmester, Bleckede (DE)

Correspondence Address: KEVIN G. ROONEY, WOOD, HERRON & EVANS, L.L.P., 2700 CAREW TOWER, CINCINNATI, OH, 45202, US

(73) Assignee: Nordson Corporation

(21) Appl. No.: 09/923,006

(22) Filed: Aug. 3, 2001

(30) Foreign Application Priority Data
Aug. 7, 2000 (DE) 10038408.0

(51) Int. Cl. B05D 1/02

(52) U.S. Cl. 427/421

(57) ABSTRACT

The invention pertains to a device and to a process for the application of liquid to a substrate, especially for the application of an adhesive to hygienic articles, in which the liquid is discharged through a liquid outlet (36) of a nozzle unit (12) and applied to a substrate, where the substrate is in relative motion with respect to the nozzle unit (12), and in which the liquid, after emerging from the liquid outlet (36) of the nozzle unit (12), is influenced by two gas streams, the two gas streams being produced by two slot nozzles (58, 60), each of which has an elongated gas outlet (62). The invention is characterized in that the elongated gas outlets (62) of the slot nozzles (58, 60), extend essentially in the direction of relative motion (64) between the substrate and the nozzle unit (12), and in that the gas streams emerging through the gas outlets (62) are adjusted in such a way that the liquid filament or ribbon emerging from the liquid outlet (36) is caused to execute an oscillating motion transverse to the direction of relative motion (64) between the substrate and the nozzle unit (12).

This application claims the benefit of German Application No. 10038408.0, filed Aug. 7, 2000, under 35 U.S.C. § 119, the disclosure of which is hereby fully incorporated by referenced herein.

### FIELD OF THE INVENTION

The present invention pertains to a process for applying a viscous liquid to a substrate, and especially for applying an adhesive to hygienic articles.

### BACKGROUND OF THE INVENTION

Devices and processes for dispensing and applying liquids onto various objects (substrates) are used for various industrial applications; for example, adhesives, dyes, or the like are dispensed in the form of two-dimensional areas, beads, or dots onto hygienic articles, automotive parts, packaging materials, furniture, or paper. Devices of this type are also often referred to as “applicator heads” and constitute one part of a more complicated application system, which includes a tank, a feed pump, lines, valves, and a control unit. The substrate is moved relative to the device by a transport device such as a conveyor belt.

Depending on the specific application in question, different requirements can be imposed on the application pattern or design produced on the substrate, that is, on the extension of the viscous fluid or liquid in two or three dimensions. In processes and devices of the type described above, the application pattern is largely controlled by streams of gas, which act on the emerging liquid filament or ribbon. The emerging gas streams can stretch the liquid filament or set it in rotation.

An applicator head for applying two-dimensional areas of thermoplastic material is known from U.S. Pat. No. 4,720,252. The device has a slot nozzle unit with a slit-like opening, through which the liquid material emerges. After the liquid material has emerged, it is acted on by two streams of gas, which emerge from elongated slots which are parallel to the opening of the slot nozzle. The slots are arranged crosswise to the direction in which the substrate is moving relative to the device, so that the liquid material is applied to the substrate in such a way that a two-dimensional area is covered.

A general objective of the present invention is to provide a process and a device for applying liquid to a substrate of the type described above, in a precise application pattern. In accordance with another aspect, the objective is to bond an elastic tape to a hygienic article using an applied ribbon or filament of adhesive in such a way that the elastic tape remains elastically deformable.

### SUMMARY OF THE INVENTION

The invention accomplishes various objectives of the type described above by providing elongated gas outlets of slot nozzles extending essentially in the direction of the relative motion between a substrate and a nozzle unit. Additionally, the gas streams emerging from the gas outlets are adjusted in such a way that the liquid filament or ribbon emerging from a liquid outlet of the nozzle unit is caused by the gas streams to execute an oscillating movement crosswise to the direction of the relative motion between the substrate and nozzle unit.

In a related aspect, a device of the type described above is arranged relative to the substrate during operation in such a way that the elongated gas outlets of the slot nozzles extend essentially in the direction of the relative motion between the substrate and the nozzle unit.

In accordance with the invention, the elongated, slit-like gas outlets of the slot nozzles for producing the gas streams are oriented in the direction of relative motion between the substrate and the device and not crosswise to the direction of relative motion as in conventional meltblown technology. As a result of the orientation of the elongated gas outlets and the oscillating movement of the liquid filament or ribbon as called for in the invention, it is possible to produce an application pattern with sharply defined boundaries. It also becomes very easy to produce a wavy application pattern on the substrate.

The surprising discovery was made that, by allowing the two gas streams to emerge at essentially the same flow velocity through gas outlets of essentially identical design, it is easy to make the liquid filament or ribbon oscillate in the manner called for by the invention, that is, to move from side to side crosswise to the direction of relative motion. The two gas outlets are preferably the same distance away from the liquid outlet and are symmetrical with respect to it. An oscillating, pendulum-like movement of the liquid filament or ribbon is obtained when the two gas streams are adjusted to flow at the same velocity and to act identically on both sides of the liquid filament or ribbon. After the liquid strand has been pushed over to one side by one of the two gas streams, the gas stream on the opposite side is then able to influence it more strongly, and the strand is thus pushed back in the opposite direction. The first gas stream is then able to exert the greater effect and pushes the strand back again. The end result is thus an oscillating motion. This effect is promoted by allowing the gas streams to strike the emerging liquid filament or ribbon at an acute angle.

A preferred exemplary embodiment of the process is characterized in that the liquid outlet is elongated and essentially parallel to the gas outlets, extending essentially in the direction of relative motion between the substrate and the nozzle unit. As a result of the elongated, slit-like design of the liquid outlet, the gas streams formed by the slot nozzles are able to influence the liquid ribbon in a more uniform manner, for a ribbon-like strip of liquid offers a greater surface area for the gas streams to impact than a cylindrical liquid filament would, the gas streams being also preferably ribbon-like.

It is especially preferred for the relative velocity between the substrate and the nozzle unit and the flow velocity of the gas streams to be adjusted so that, as a result of the oscillating motion of the liquid filament or ribbon, an essentially wave-like bead of liquid is formed on the substrate. In this way it is possible to produce an application pattern of adhesive in which the adhesive is uniformly distributed and achieves a uniform pattern at a low rate of adhesive consumption per unit area. The process is preferably conducted in such a way that the relative velocity is constant and that the oscillating motion is essentially a sinusoidal oscillation, so that the application pattern obtained is essentially in the form of a sine wave.

In accordance with a preferred embodiment of the invention for producing hygienic articles, the process is implemented with a liquid which consists of a curable hot-melt adhesive, which is elastically deformable after it has cured, and which is applied to hygienic articles such as diapers or the like. In this embodiment, the bead of adhesive applied to the hygienic article serves to hold an elastically deformable elastic tape in place. As a result, the elastic tape can be permanently attached to the hygienic article in such a way that the stretchability of said elastic tape is not impaired.

In another aspect, the invention provides gas outlets which are longer than the liquid outlet. This leads to the advantageous result that the emerging liquid filament or ribbon is embedded in the elongated, sheet-like streams of gas.

Especially favorable results in the attachment of elastic tapes to diapers are achieved when the liquid outlet has a length of 0.5-5 mm in the direction of relative motion. In this case, the width of the liquid outlet crosswise to the direction of relative motion is in the range of 0.1-0.5 mm.

The slot nozzles are preferably set up at an acute angle in the range of 10°-45° to the flow direction of the liquid filament emerging from the liquid outlet.

### BRIEF DESCRIPTION OF THE DRAWINGS

The invention is described in greater detail below on the basis of exemplary embodiments of the process according to the invention and of the device according to the invention with reference to the attached drawings:

FIG. 1 shows a cross-sectional view of an applicator head according to the invention with a nozzle unit;

FIG. 2 shows an enlarged cross-sectional view of a part of the nozzle unit;

FIG. 3 shows a side view of the nozzle unit;

FIG. 4 shows another side view of the nozzle unit;

FIG. 5 shows a schematic side view of the nozzle unit to illustrate the flow of liquid;

FIG. 6 shows another schematic side view of the nozzle unit to illustrate the flow of gas;

FIG. 7 shows an exploded view of the nozzle unit in perspective; and

FIG. 8 shows a schematic diagram of the liquid and the gas streams emerging from the nozzle unit.

### DETAILED DESCRIPTION OF THE PREFERRED EMBODIMENTS

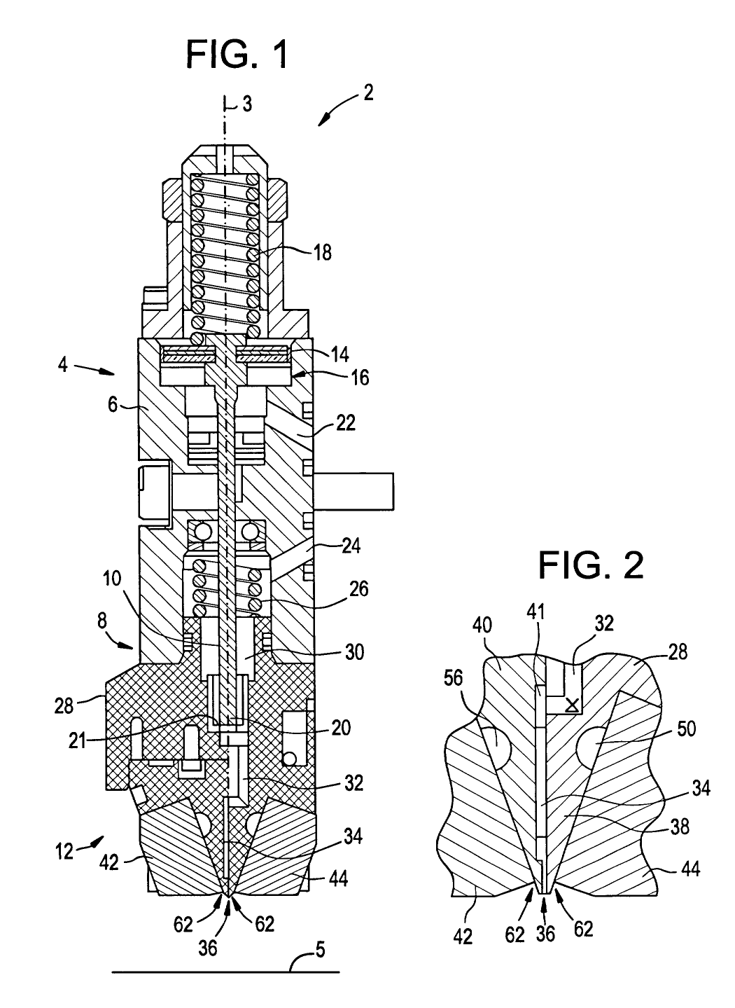

The device shown in FIG. 1 for applying a liquid to a substrate 55 in relative motion with respect to the device is also referred to as an applicator head 2. The applicator head 2 is one component of a liquid application system, which consists of a liquid source. In the exemplary embodiment, the liquid is an adhesive. The system further includes a pump, lines for carrying the liquid from the liquid source to the applicator head 2 and the necessary lines and valves required for this purpose and a control unit for the open-loop and closed-loop control of the individual components of the application system.

The applicator head 2 has an upper control section 4 with a housing or base body 6. The control section 4 has the job of actuating a valve arrangement 8 with an elongated, movable, needle-shaped valve body 10 in order to release or interrupt the flow of liquid within the nozzle unit 12.

The control section 4 and the valve arrangement 8 operate together to dispense the liquid. Specifically, a piston 14 is designed to slide in a cylinder 16, which is formed in base body 6. Piston 14 is rigidly connected to the valve body 10. A spiral spring 18 presses the piston 14 and the valve body 10 toward the nozzle unit 12 so that the lower, hemispherical end section 20 of the valve body 10 comes into contact with a valve seat 21. With the help of solenoid-operated valves (not shown), which are mounted on the side of the base body 6, compressed air can be introduced from a compressed air source through a compressed air channel 22 into the cylinder chamber 16 underneath the piston 14. Piston 14 is pushed upward by this compressed air, as viewed in FIG. 1, together with the valve body 10, and against the force of the coil spring 18. The end section 20 thus disengages from the valve seat 21. By actuating the solenoid-operated valves, therefore, it is possible to interrupt or to release the flow of liquid as desired.

A liquid feed channel 24, which is provided in the base body 6 in the form of a slanted bore, is connected to a source of adhesive from which, by means of a suitable feed device, adhesive or some other type of liquid can be supplied. Liquid flows through the feed channel 24, into a cylindrical space 26, and from there onward to the nozzle unit 12.

As can be seen in FIGS. 1, 5 and 6, the cylindrical space 26 communicates with a channel 30, formed in a base body 28 of the nozzle unit 12. When the valve is open, liquid can flow through an outlet channel 32. The lower section of the outlet channel 32 is formed as a slot-like channel 34, which leads to an elongated, slot-shaped liquid outlet 36, from which the liquid is discharged.

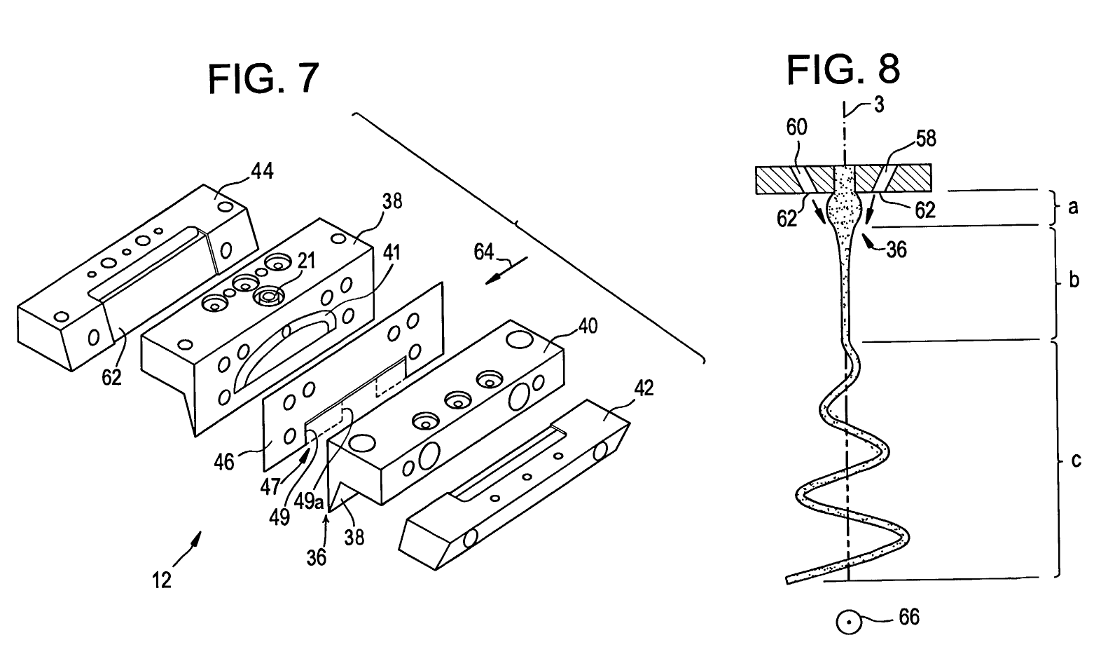

As illustrated in FIGS. 2-7, in addition to the base body 28 with a mouthpiece holder 38 formed in it, the nozzle unit 12 also has a mouthpiece 40, two air nozzle parts 42, 44 and an insert plate 46 (compare FIG. 7). As can be seen especially clearly in FIG. 6, the compressed gas, preferably compressed air, can be introduced through a connecting bore into the nozzle unit 12. From the connecting bore 47, one or more channels 48 which communicate with the connecting bore 47, extend vertically downward relative to a central axis 3. These channels 47 communicate in turn with an elongated recess 50. Another channel 52, which leads to a vertical bore 54, also extends through the base body 28. Part of this vertical bore is in the mouthpiece 40 and part is in the air nozzle part 42. The channel 54 leads to a transverse bore 56. The two transverse bores 50, 56 communicate with slot nozzles 58, 60, which are at a slant, i.e., at an acute angle relative to the central axis 3. These slot nozzles 58, 60 lead to the elongated, slit-like gas outlets 62. During operation, sheet-like, elongated streams of gas emerge through the gas outlets 62.

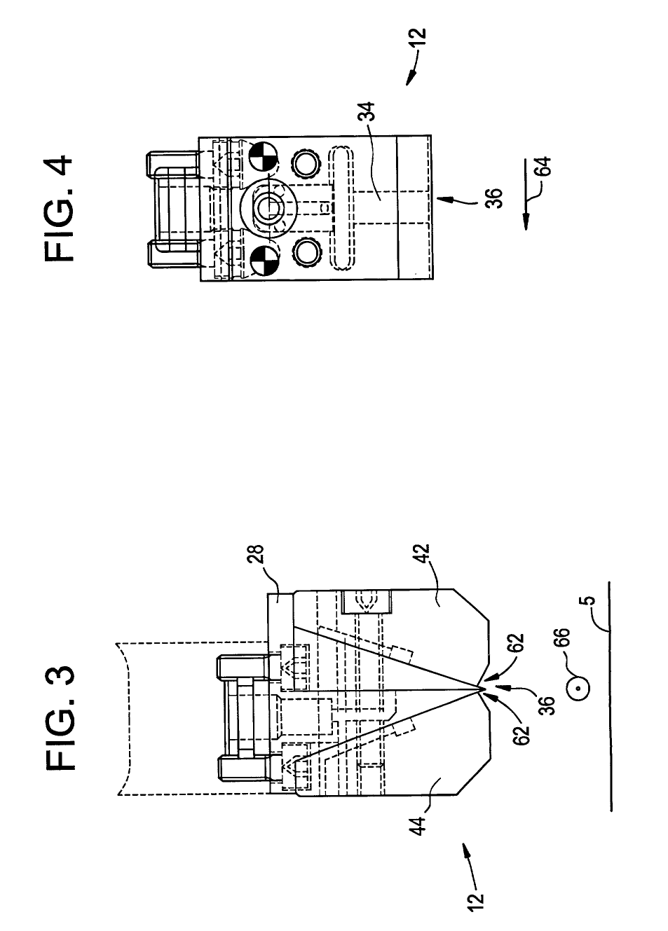

In the exemplary embodiment according to FIGS. 3 and 4, the liquid outlet 36 is relatively short, with a length (measured in the direction of relative motion) of only 2 mm. It can, however, be adapted in any way desired to the actual application. As FIG. 7 shows, the length of the liquid outlet 36 is predetermined by a rectangular cutout 49 or 49a (shown in phantom) formed in the insert plate 46. The length of this cutout can be adapted to the actual application. Both the elongated liquid outlet 36 and the gas outlets 62 extend in the direction of relative motion between the applicator head 2 with nozzle unit 12 and the substrate 5.

In FIGS. 4 and 7, the direction of relative motion is indicated by the arrow 64, and in FIG. 3 it is indicated by the symbol 66. Symbol 66 is an arrow pointing out from the plane of the drawing toward the observer. Of course, arrow 64 could also point in the opposite direction, in which case the direction of relative motion in FIG. 3 would point into the plane of the drawing, away from the observer. The essential point with respect to the arrangement according to the invention is that, in order to achieve the previously described effects and advantages of the invention, the gas outlets 62 and the liquid outlet 36 must extend in the direction of relative motion.

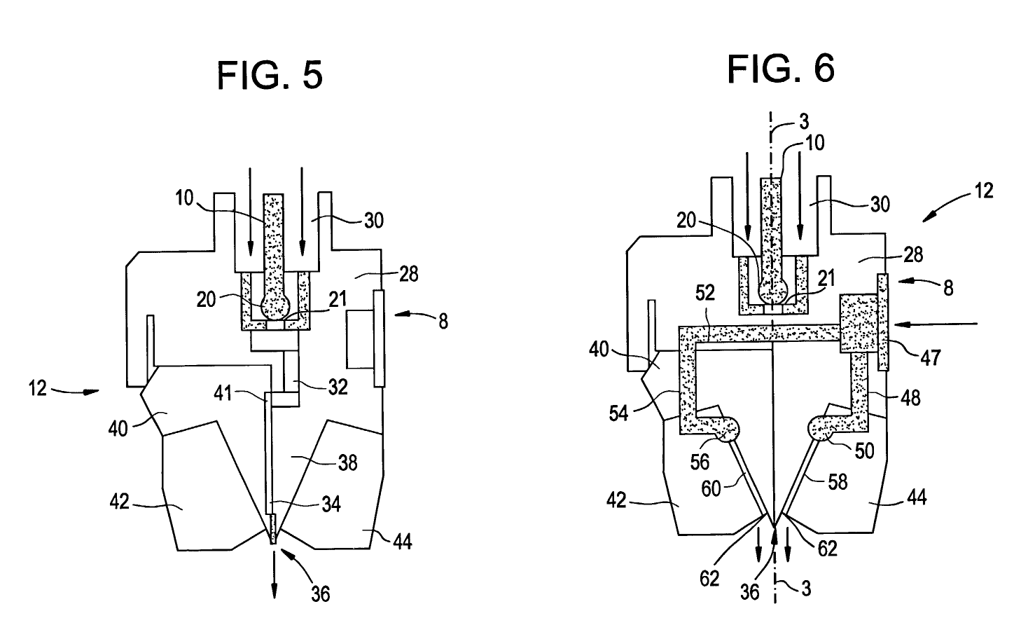

As can be derived from FIG. 5, the channel 32 connects to a transverse bore 41, which is formed in the mouthpiece 40. This transverse bore can have the shape of a coat hanger, as illustrated in FIG. 7. Like the air nozzle parts 42, 44, the slot nozzles 58, 60 are symmetrical with respect to the central axis 3 and the liquid outlet 36.

In the form of a schematic diagram, FIG. 8 shows the production of an oscillating filament or ribbon of adhesive according to the invention. As indicated by the arrows, streams of gas emerge through the outlets 62 of the slot nozzles 58, 60 in the direction of the adhesive or filament ribbon, which has emerged from the liquid outlet 36 of the nozzle unit. In a first section “a”, the filament of adhesive first expands slightly and is then stretched out in a section “b” by the two elongated gas streams. In a section “c”, the oscillating motion according to the invention then begins, the amplitude of the oscillating filament gradually increasing. As a result of the direction of relative motion between the applicator head and the substrate, indicated by the arrow 66 in FIG. 8 and FIG. 3, a wave-like application pattern of the adhesive filament, possibly in the form of a sine wave, is produced on the substrate.

1. Process for applying liquid to a substrate, especially for applying adhesive to hygienic articles, in which liquid is conveyed from a liquid source to a nozzle unit (12), flows through an outlet channel (32) of the nozzle unit (12), is discharged through a liquid outlet (36) of the nozzle unit (12), and is applied to a substrate; where the substrate is in motion relative to the nozzle unit (12);
and in which the liquid, after it has emerged from the liquid outlet (36) of the nozzle unit (12), but before it is applied to the substrate, is acted on by two streams of gas, one acting on each side of the discharged liquid filament or ribbon; where the two gas streams are produced by two slot nozzles (58, 60), each of which has an elongated gas outlet (62), the nozzles being set up opposite each other, and between which the outlet (36) of the liquid outlet channel (32) is located, characterized in that the elongated gas outlets (62) of the slot nozzles (58, 60) extend essentially in the direction of relative motion (64) between the substrate and nozzle unit (12), and in that the gas streams emerging through the gas outlets (62) are adjusted so that the liquid filament or liquid ribbon emerging from the liquid outlet (36) is caused by the gas streams to execute an oscillating motion transverse to the direction of the relative motion (64) between the substrate and the nozzle unit (12).
